(19) United States
(12) Patent Application Publication
(10) Pub. No.: US 2026/0003379 A1
(43) Pub. Date: Jan. 1, 2026

(54) LOW DROPOUT REGULATOR, SEMICONDUCTOR DEVICE INCLUDING SAME AND METHOD OF CONTROLLING SAME

(71) Applicant: SAMSUNG ELECTRONICS CO., LTD., SUWON-SI (KR)

(72) Inventors: SEKI KIM, Suwon-si (KR); HYUNSEOK NAM, Suwon-si (KR); TAKAHIRO NOMIYAMA, Suwon-si (KR)

(21) Appl. No.: 19/243,075

(22) Filed: Jun. 19, 2025

(30) Foreign Application Priority Data
Jun. 26, 2024 (KR) 10-2024-0083575

(51) Int. Cl. G05F 1/573; G05F 1/575; G05F 1/59

(52) U.S. Cl. CPC G05F 1/573; G05F 1/575; G05F 1/59

(57) ABSTRACT

A low-dropout (LDO) regulator includes a plurality of power transistors connected in parallel between an input node to which an input voltage is applied and an output node, a comparator that compares an output voltage of the output node with a reference voltage and outputs a control signal, a controller that outputs a control code that controls at least some of the plurality of transistors based on the control signal such that an output current equal to an aim current flows through the output node, and a current limit circuit that detects a target current output from a sample transistor connected to the input node and outputs a target code corresponding to the target current. The controller determines a limit code based on the target code and a preset maximum current, and outputs the control code within a range defined by the limit code.

### CROSS-REFERENCE TO RELATED APPLICATIONS

This application claims priority under 35 U.S.C. § 119 to Korean Patent Application No. 10-2024-0083575, filed on Jun. 26, 2024, the disclosure of which is incorporated by reference herein in its entirety.

### TECHNICAL FIELD

Embodiments of the present disclosure relate to a low-dropout (LDO) regulator, a semiconductor device including the same, and a method of controlling the same.

### DISCUSSION OF RELATED ART

A low-dropout (LDO) regulator, which is a type of voltage regulator that supplies a constant power voltage to an integrated circuit, may be a linear regulator that achieves high power efficiency, for example, when the potential difference between the input and output voltages is small.

Generally, an LDO regulator is designed as an analog circuit. When an LDO regulator is implemented as an analog circuit, the size of the circuit increases and the control precision of the output voltage decreases.

Accordingly, research has increasingly focused on digital LDO regulators designed with digital circuits that offer smaller circuit sizes and improved power efficiency.

### SUMMARY

Embodiments of the present disclosure provide an LDO regulator that stably limits an output current regardless of an operating environment.

According to an embodiment, a low-dropout (LDO) regulator includes a plurality of power transistors connected in parallel between an input node to which an input voltage is applied and an output node, a comparator that compares an output voltage of the output node with a reference voltage and outputs a control signal based on the comparison, a controller that outputs a control code that controls at least some of the plurality of power transistors based on the control signal such that an output current equal to an aim current flows through the output node, and a current limit circuit that detects a target current output from a sample transistor connected to the input node and outputs a target code corresponding to the target current. The controller determines a limit code based on the target code and a preset maximum current, and outputs the control code within a range defined by the limit code.

According to an embodiment, a method of controlling a low-dropout (LDO) regulator includes detecting a target current flowing through a sample transistor connected between an input node to which an input voltage is applied and a first node to which an output voltage is applied, outputting a target code corresponding to the target current based on the target current, determining a limit code based on the target code and a preset maximum current, and outputting a control code that controls at least some of a plurality of power transistors connected between the input node and an output node within a range defined by the limit code such that an output current equal to an aim current flows through the output node to which the output voltage is applied.

According to an embodiment, a semiconductor device including a low-dropout (LDO) regulator that operates based on a digital code includes a plurality of power transistors connected between an input node and an output node, a first comparator that compares an output voltage applied to the output node with a first reference voltage and outputs a first control signal based on the comparison, a controller that outputs a control code that turns on at least some of the plurality of power transistors based on the first control signal such that an output current equal to an aim current is output through the output node, and a current limit circuit that detects a target current output from a sample transistor connected to the input node and outputs a target code corresponding to the target current. The controller determines a limit code based on the target code and a preset maximum current, and outputs the control code within a range defined by the limit code.

An LDO regulator according to an embodiment of the present disclosure may stably limit an output current regardless of an operating environment.

### BRIEF DESCRIPTION OF THE FIGURES

The above and other objects and features of the present disclosure will become more apparent by describing in detail embodiments thereof with reference to the accompanying drawings.

FIG. 1 is a circuit diagram illustrating a low-dropout (LDO) regulator according to an embodiment of the present disclosure.

FIG. 2 is a diagram illustrating a controller according to an embodiment.

FIG. 3 is a circuit diagram illustrating a configuration of a current limit circuit according to an embodiment.

FIG. 4 is a circuit diagram illustrating a current limit circuit according to an embodiment.

FIG. 5A is a circuit diagram illustrating a current limit circuit in a first state according to an embodiment.

FIG. 5B is a circuit diagram illustrating a current limit circuit in a second state according to an embodiment.

FIG. 6 is a circuit diagram illustrating an LDO regulator including a current limit circuit according to an embodiment.

FIG. 7 is a flowchart illustrating a method of controlling an LDO regulator according to an embodiment.

FIG. 8 is a flowchart illustrating a method of generating a target code from a target current according to an embodiment.

FIG. 9 is a flowchart illustrating a method of determining a limit code according to an embodiment.

FIG. 10 is a flowchart illustrating a method of controlling a control code by a controller according to an embodiment.

FIG. 11 is a circuit diagram illustrating an LDO regulator according to an embodiment.

FIG. 12 is a flowchart illustrating a method of controlling a control code by a controller according to an embodiment.

### DETAILED DESCRIPTION

Embodiments of the present disclosure will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

It will be understood that when a component is referred to as being “on”, “connected to”, “coupled to”, or “adjacent to” another component, it can be directly on, connected, coupled, or adjacent to the other component, or intervening components may be present. Other words used to describe the relationships between components should be interpreted in a like fashion.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art, for example, within ±30%, 20%, 10% or 5% of the stated value. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

Embodiments of the present disclosure provide an improved low-dropout (LDO) regulator that maintains stable current limiting across varying operating environments, including changes in process, voltage, and temperature. An LDO regulator according to a comparative example may rely on analog current limiting mechanisms that are prone to inaccuracies under such conditions. For example, at high temperatures or low voltages, analog systems may struggle to precisely regulate the number of turned-on (active) power transistors, resulting in unstable output currents or potential overcurrent damage to the circuit. Additionally, such analog designs may increase the complexity and size of the LDO regulator, making the LDO regulator less suitable for compact, high-performance semiconductor devices.

To improve upon an LDO regulator according to the comparative example, embodiments provide a digital LDO regulator including a current limit circuit that may detect the current flowing through a sample transistor. This detected current may be converted into a digital target code, which the controller may use to calculate a limit code that represents the maximum number of power transistors that can be safely turned on (activated). The controller may dynamically adjust the control code to turn on (activate) or turn off (deactivate) power transistors based on real-time conditions. As a result, the output current may remain within a safe, predetermined range.

By leveraging digital control, the LDO regulator according to embodiments may provide precise and consistent current limiting despite variations in process, voltage, and temperature conditions, resulting in reliable operation in diverse environments. In addition, the LDO regulator according to embodiments may reduce complexity and occupied area, resulting in an LDO regulator suitable for integration into modern systems-on-chip (SoCs) and other space-constrained applications. Furthermore, the LDO regulator according to embodiments may improve safety by preventing damage caused by excessive current, and may offer scalability, enabling compatibility with a wide range of load requirements. Thus, embodiments may provide dynamic determination of the appropriate number of active power transistors through the integration of a sample transistor and a current limit circuit, providing an efficient, robust, and compact solution for modern semiconductor devices.

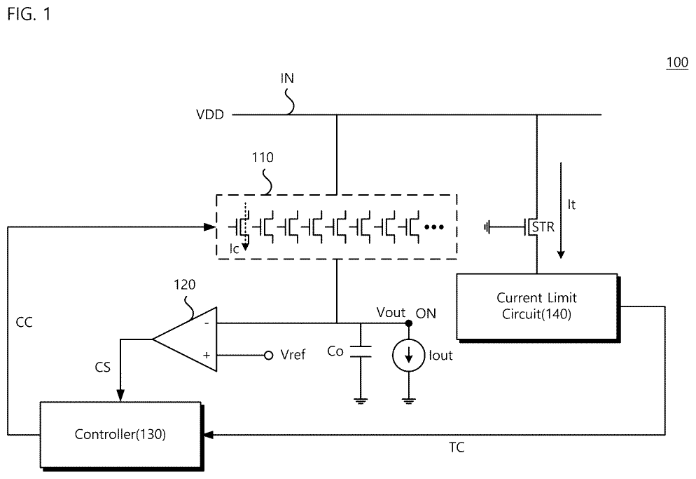

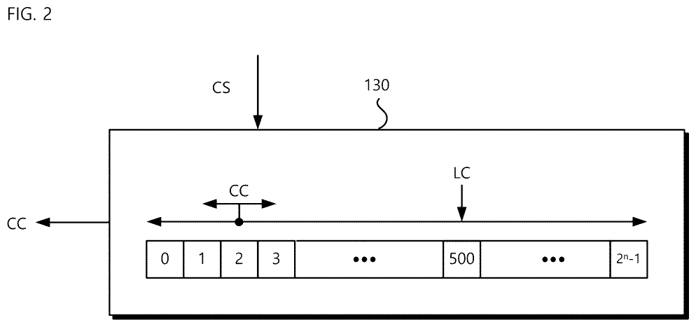

FIG. 1 is a circuit diagram illustrating an LDO regulator according to an embodiment of the present disclosure. FIG. 2 is a diagram illustrating a controller according to an embodiment.

Referring to FIG. 1, an LDO regulator 100 (also referred to as an LDO regulator circuit) according to an embodiment may include a plurality of power transistors 110, a comparator 120, a controller 130 (also referred to as a controller circuit), a sample transistor STR, and a current limit circuit 140.

The LDO regulator 100 may include the plurality of power transistors 110 connected between an input node IN to which an input voltage VDD is applied and an output node ON through which an output voltage Vout is output.

For example, the LDO regulator 100 may include the plurality of power transistors 110 connected in parallel between the input node IN and the output node ON.

In this case, for example, each of the plurality of power transistors 110 may be implemented with a p-type metal-oxide semiconductor (PMOS) transistor.

According to an embodiment, a first current Ic may flow from the input node IN to the output node ON through each turned-on power transistor among the plurality of power transistors 110.

Therefore, the LDO regulator 100 may control the amount of an output current out output through the output node ON by controlling the number of power transistors that are turned on among the plurality of power transistors 110.

The LDO regulator 100 may turn on (or turn off) at least some of the plurality of power transistors 110 such that the output current Iout flows from the input node IN to the output node ON.

In this case, for example, the LDO regulator 100 may be included inside a semiconductor device or a system-on-chip (SoC). Accordingly, the output node ON may be connected to at least one element included in the semiconductor device or the SoC.

For example, when the LDO regulator 100 is included in an application processor (AP), the output node ON may be connected to at least some of a central processing unit (CPU), a display controller, and a memory controller.

Therefore, the LDO regulator 100 according to an embodiment may output the output voltage Vout or the output current Iout required from the SoC or at least one element included in the SoC through the output node ON.

For example, the LDO regulator 100 may turn on three power transistors when the output current Iout equal to about three times the first current Ic is required from the SoC.

In addition, as another example, the LDO regulator 100 may turn on six power transistors when the output current Iout equal to about six times the first current Ic is required from the SoC.

For example, in an embodiment, if the SoC requires an output current Iout equal to about three times the first current Ic, the LDO regulator 100 may turn on three power transistors 110 to provide the necessary current. Similarly, in an embodiment, if the SoC requires an output current Iout equal to about six times the first current Ic, the LDO regulator 100 may turn on six power transistors 110 to meet this demand.

In this case, it is assumed that the sizes of the plurality of power transistors 110 are the same.

In addition, the LDO regulator 100 may include the comparator 120, which compares the output voltage Vout with a reference voltage Vref and outputs a control signal CS.

According to an embodiment, the comparator 120 may receive the output voltage Vout and the reference voltage Vref through two input terminals, respectively. Furthermore, the comparator 120 may compare the output voltage Vout with the reference voltage Vref and output the control signal CS through the output terminal.

For example, when the output voltage Vout is greater than or equal to the reference voltage Vref, the comparator 120 may output the control signal CS having a high level.

In addition, as another example, when the output voltage Vout is lower than the reference voltage Vref, the comparator 120 may output the control signal CS having a low level.

In addition, the LDO regulator 100 may include the controller 130 connected to the comparator 120 and the plurality of power transistors 110.

In this case, the controller 130 may execute software (or a program) to control at least one other component (e.g., the plurality of power transistors 110) of the LDO regulator 100 and perform various data processing or operations. In addition, the controller 130 may include, e.g., a central processing unit (CPU) or a microprocessor, and may control the overall operation of the LDO regulator 100. Accordingly, in embodiments, the operation performed by the LDO regulator 100 is performed under the control of the controller 130.

According to an embodiment, the controller 130 may control at least some of the plurality of power transistors 110 based on the control signal CS.

For example, the controller 130 may output a control code CC to turn on at least some of the plurality of power transistors 110 based on the level of the control signal CS such that the output current Iout about equal to a target current flows through the output node ON.

In this case, for example, the target current is the amount of a current required from a device (or chip) connected to the LDO regulator 100 through the output node ON.

That is, the controller 130 may control at least some of the plurality of power transistors 110 through the control code CC such that the output current Iout about equal to the target current flows through the output node ON.

For example, the controller 130 may output the control code CC to turn on at least one of the plurality of power transistors 110 in response to the control signal CS having a low level.

For example, according to an embodiment, the controller 130 may generate a control code CC to turn on some of the power transistors among the plurality of power transistors 110, adjusting the output current Iout so that it approximately matches the target current at the output node ON. In this context, the target current may represent the specific current demand from a device or chip connected to the LDO regulator 100 via the output node ON. In other words, the controller 130 may regulate the power transistors 110 using the control code CC such that the output current Iout aligns with the target current. For example, when the control signal CS is at a low level, the controller 130 may output the control code CC to turn on at least one of the power transistors 110.

As another example, the controller 130 may output the control code CC to turn off at least one of the plurality of power transistors 110 in response to the control signal CS having a high level.

According to an embodiment, the number of power transistors to be turned on may vary depending on the amount of required output current Iout.

Therefore, the control code CC may be generated to include information about the number of power transistors to be turned on (or turned off) among the plurality of power transistors 110.

For example, when the control code CC is generated with n bits, where n is a positive integer, the controller 130 may output the control code CC corresponding to the number of power transistors to be turned on among 2ⁿ power transistors.

In addition, the LDO regulator 100 may include the current limit circuit 140, which outputs a target code TC based on a target current It output from the sample transistor STR.

For example, the current limit circuit 140 may detect the target current It output from the sample transistor STR connected to the input node IN. In addition, the current limit circuit 140 may output the target code TC corresponding to the detected target current It.

In this case, the target code TC may be referenced as a digital code that includes information about the target current It (or a voltage corresponding to the target current It).

For example, according to an embodiment, when the control signal CS is at a high level, the controller 130 may output a control code CC to turn off at least one of the power transistors 110.

In an embodiment, the number of power transistors 110 turned on may vary based on the required output current Iout.

To achieve this, the control code CC may be generated to specify how many of the power transistors 110 should be turned on or off. For example, if the control code CC is represented using n bits, it can correspond to the number of power transistors 110 turned on among 2ⁿ available transistors 110.

Additionally, the LDO regulator 100 may include a current limit circuit 140 that generates a target code TC based on the target current It flowing through the sample transistor STR.

The current limit circuit 140 may detect the target current It from the sample transistor STR connected to the input node IN and produce a corresponding target code TC. This target code TC may be a digital representation including information about the detected target current It or the voltage associated with it.

Referring to FIGS. 1 and 2 together, the controller 130 according to an embodiment may determine a limit code LC based on the target code TC.

For example, the controller 130 may identify the amount of the target current It based on the target code TC.

Furthermore, the controller 130 may determine (or calculate) the maximum number of power transistors that are turned on among the plurality of power transistors 110, based on the amount of the target current It and the amount of the preset maximum current.

For example, in an embodiment, when the target current It is about 2 mA and the maximum current is about 1 A, the controller 130 may determine that up to 500 power transistors among the plurality of power transistors 110 are turned on.

For example, in an embodiment, when the target current It is about 5 mA and the maximum current is about 1 A, the controller 130 may determine that up to 200 power transistors among the plurality of power transistors 110 are turned on.

Furthermore, the controller 130 may determine the limit code LC corresponding to the maximum number. For example, the controller 130 may determine the code 110 corresponding to the maximum number as the limit code LC.

According to an embodiment, the controller 130 may output the control code CC within a range of the limit code LC or less. For example, according to an embodiment, the controller 130 may output the control code CC within a range defined by the limit code LC.

For example, the controller 130 may output the control code CC corresponding to 498 power transistors within the range of the limit code LC or less corresponding to 500 power transistors, such that 498 of the plurality of power transistors 110 are turned on.

For example, the controller 130 may output the control code CC within the range of the limit code LC or less based on the control signal CS transmitted from the comparator 120.

That is, the controller 130 may output the control code CC within the range of the limit code LC or less based on the control signal CS such that the maximum number or less of power transistors among the plurality of power transistors 110 are turned on.

For example, when the output voltage Vout is lower than the reference voltage Vref, the controller 130 may output the control code CC to additionally turn on one power transistor within the range of the limit code LC or less in response to the control signal CS.

That is, when the output voltage Vout is lower than the reference voltage Vref, the controller 130 may increase the control code CC by the unit code within the range of the limit code LC or less in response to the control signal CS.

In this case, for example, the unit code may be understood as a digital code corresponding to a control operation for turning on one of the plurality of power transistors 110.

As another example, the controller 130 may output the control code CC to turn off one power transistor in response to the control signal CS when the output voltage Vout is greater than the reference voltage Vref.

That is, when the output voltage Vout is greater than the reference voltage Vref, the controller 130 may reduce the control code CC by the unit code in response to the control signal CS.

Referring to the above-described configurations, the current limit circuit 140 according to an embodiment may identify the amount of a current (e.g., the target current It) flowing from the input node IN to the output node ON through the sample transistor STR.

Furthermore, the controller 130 may determine the limit code LC corresponding to the maximum number of power transistors that may be turned on among the plurality of power transistors 110, based on the target current It.

In addition, the controller 130 may control at least some of the plurality of power transistors 110 by outputting the control code CC within the range of the limit code LC.

That is, the controller 130 may set the limit code LC for controlling the LDO regulator 100 to output a current within the range of the maximum current or less by using the sample transistor STR.

Thus, the LDO regulator 100 according to an embodiment of the present disclosure may stably limit the output current Iout regardless of the operating environment (e.g., process, voltage, or temperature).

For example, according to an embodiment, the current limit circuit 140 may detect the amount of current (e.g., the target current It) flowing from the input node IN to the output node ON via the sample transistor STR.

Using this detected target current It, the controller 130 may determine the limit code LC, which represents the maximum number of power transistors 110 that can be turned on.

The controller 130 may then regulate the plurality of power transistors 110 by generating and outputting a control code CC that stays within the range defined by the limit code LC.

Thus, according to embodiments, the controller 130 may leverage the limit code LC to ensure the LDO regulator 100 operates within the maximum allowable current, using the sample transistor STR for accurate control. As a result, the LDO regulator 100 may reliably restrict the output current Iout to safe levels, regardless of variations in the operating environment, such as, for example, changes in process, voltage, or temperature For example, embodiments of the present disclosure may achieve stability by dynamically detecting the target current It through a sample transistor and using the limit code LC to precisely control the number of power transistors that are turned on. By accounting for variations in process, voltage, and temperature, the LDO regulator 100 may provide consistent performance, prevent excessive current that could damage components, and maintain the efficiency and reliability of the system in diverse conditions.

In addition, the LDO regulator 100 may further include an output capacitor Co connected between the output node ON and the ground.

According to an embodiment, when the input voltage VDD decreases or the amount of the aim current required through the output node ON increases, the charges stored in the output capacitor Co may move to the output node ON.

Accordingly, the LDO regulator 100 may minimize or reduce the time during which the amount of the output current Iout output through the output node ON remains relatively small compared to the aim current.

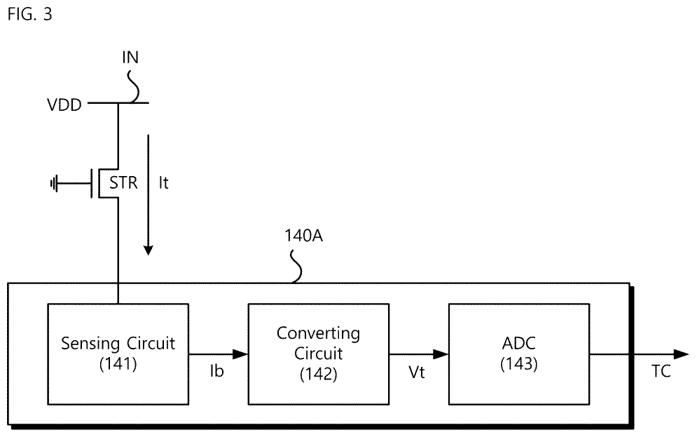

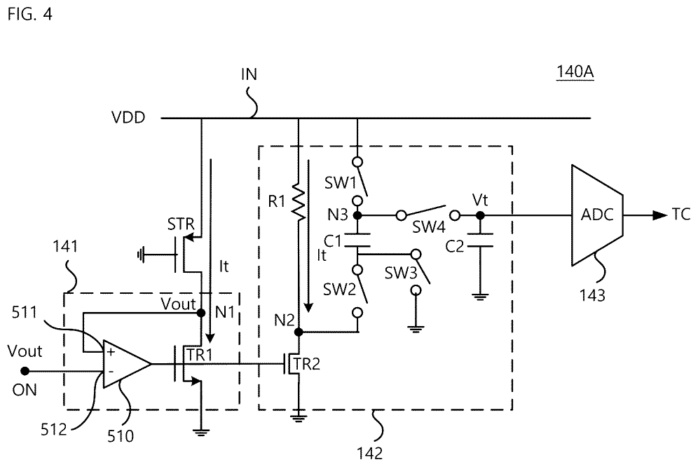

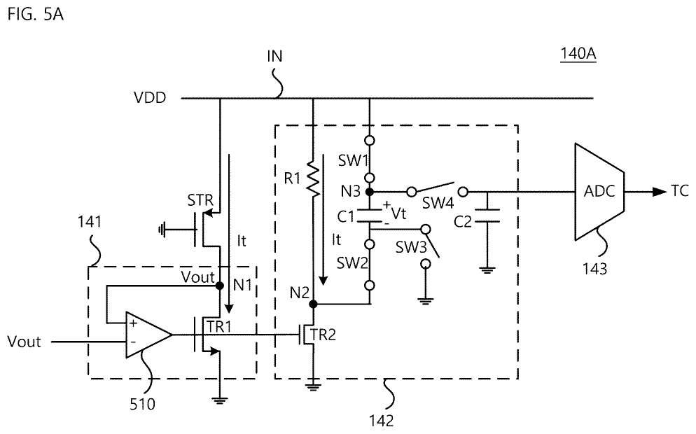

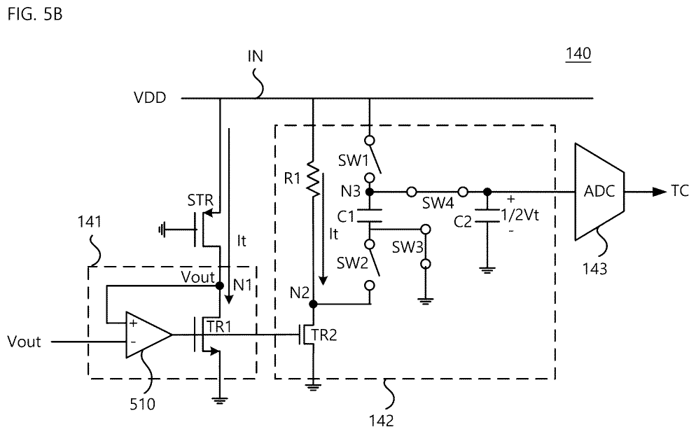

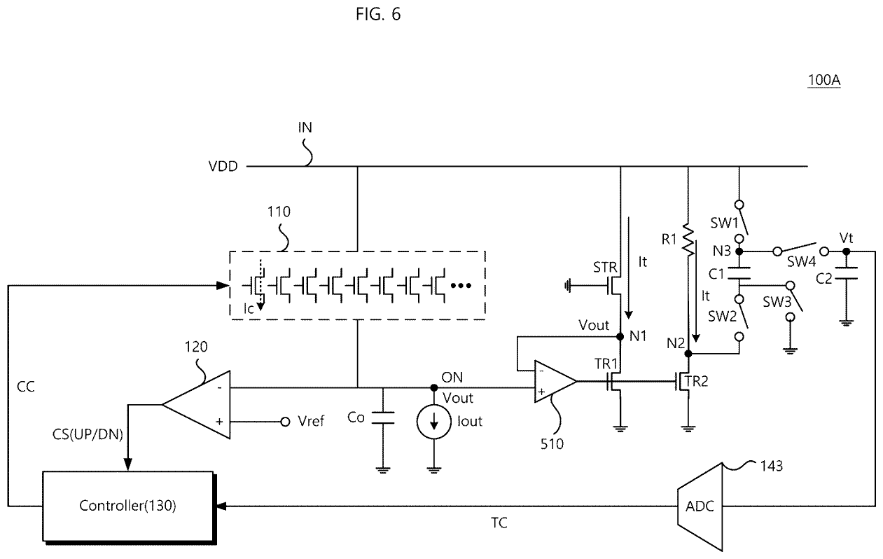

FIG. 3 is a circuit diagram illustrating a configuration of a current limit circuit according to an embodiment. FIG. 4 is a circuit diagram illustrating a current limit circuit according to an embodiment. FIG. 5A is a circuit diagram illustrating a current limit circuit in a first state according to an embodiment. FIG. 5B is a circuit diagram illustrating a current limit circuit in a second state according to an embodiment. FIG. 6 is a circuit diagram illustrating an LDO regulator including a current limit circuit according to an embodiment.

Referring to FIG. 3, a current limit circuit 140A according to an embodiment may include a sensing circuit 141, a converting circuit 142, and an analog-to-digital converter (ADC) 143 (also referred to as an ADC circuit). However, embodiments are not limited thereto. For example, according to an embodiment, the ADC 143 may be implemented separately from the current limit circuit 140A and connected between the current limit circuit 140A and the controller 130.

In this case, the current limit circuit 140A illustrated in FIGS. 3 to 6 may be understood as an example of the current limit circuit 140 illustrated in FIG. 1. In addition, an LDO regulator 100A illustrated in FIG. 6 may be understood as an example of the LDO regulator 100 illustrated in FIG. 1.

Therefore, for convenience of description, the same reference numerals will be used for components that are identical or substantially identical to the components described above, and duplicate descriptions of the same components will be omitted.

The sensing circuit 141 according to an embodiment may detect the target current It output from the sample transistor STR.

For example, the sensing circuit 141 may detect the target current It flowing from the input node IN through the sample transistor STR.

Referring to FIGS. 3 and 4 together, the sensing circuit 141 according to an embodiment may include a first transistor TR1 and an error amplifier 510.

For example, the sensing circuit 141 may include the first transistor TR1 connected between the sample transistor STR and a ground. In this case, for example, the first transistor TR1 may be implemented with an n-type metal-oxide semiconductor (NMOS) transistor.

In addition, the sensing circuit 141 may include the error amplifier 510 connected to the first transistor TR1.

In this case, the output terminal of the error amplifier 510 may be connected to the gate electrode of the first transistor TR1. In addition, a first input terminal 511 of the error amplifier 510 may be connected to a first node N1 between the sample transistor STR and the first transistor TR1. In addition, a second input terminal 512 of the error amplifier 510 may be connected to the output node ON.

In addition, according to an embodiment, the output voltage Vout may be applied to the first node N1. Accordingly, the output voltage Vout may be applied to the drain electrode of the sample transistor STR.

In addition, the input voltage VDD may be applied to the source electrode of the sample transistor STR.

In addition, each of the plurality of power transistors 110 may be connected between the input node IN to which the input voltage VDD is applied and the output node ON to which the output voltage Vout is applied.

That is, the sample transistor STR may operate under the same operating environment as each of the plurality of power transistors 110.

Therefore, it may be understood that the target current It flowing through the sample transistor STR has an amount equal to an integer multiple of the first current Ic flowing through each of the plurality of power transistors 110.

For example, when each of the plurality of power transistors 110 has a size equal to a first integer multiple of the sample transistor STR, the first current Ic may have an amount equal to the first integer multiple of the target current It.

Furthermore, the target current It may flow to the ground through the first transistor TR1.

According to the above-described configurations, the sensing circuit 141 may detect the target current It flowing through the sample transistor STR.

In addition, the current limit circuit 140A according to an embodiment may include the converting circuit 142, which converts the target current It into a target voltage Vt.

For example, the converting circuit 142 may convert the target current It into the target voltage Vt corresponding to the target current It.

Referring to FIG. 4, the converting circuit 142 according to an embodiment may include a first resistor R1 and a second transistor TR2 connected in series between the input node IN and the ground.

In addition, the converting circuit 142 may include a first capacitor C1 connected between a second node N2 between the first resistor R1 and the second transistor TR2, and the input node IN.

In addition, the converting circuit 142 may include a second capacitor C2 connected between a third node N3 between the first capacitor C1 and the input node IN, and the ground.

In addition, the converting circuit 142 may include a first switch SW1 connected between the input node IN and the third node N3.

In addition, the converting circuit 142 may include a second switch SW2 connected between the first capacitor C1 and the second node N2.

In addition, the converting circuit 142 may include a third switch SW3 connected between the first capacitor C1 and the ground.

In addition, the converting circuit 142 may include a fourth switch SW4 connected between the third node N3 and the second capacitor C2.

According to an embodiment, each of the first switch SW1, the second switch SW2, the third switch SW3, and the fourth switch SW4 may repeatedly be turned on and off according to a specified cycle.

For example, each of the first switch SW1, the second switch SW2, the third switch SW3, and the fourth switch SW4 may be turned on or off according to a clock signal received from outside the LDO regulator 100A.

Referring to FIG. 5A, the third switch SW3 and the fourth switch SW4 may be turned off while the first switch SW1 and the second switch SW2 are turned on.

For example, the first switch SW1 and the second switch SW2 may be turned on in response to a clock signal having a high level. In addition, the third switch SW3 and the fourth switch SW4 may be turned off in response to the clock signal having a high level.

In this case, it is assumed that the state in which the first switch SW1 and the second switch SW2 are turned on and the third switch SW3 and the fourth switch SW4 are turned off is a first state of the current limit circuit 140A.

According to an embodiment, while the current limit circuit 140A is in the first state, the target voltage Vt may be stored in the first capacitor C1.

For example, a voltage V_{N2} expressed as Equation 1 may be applied to the second node N2.

$${V}_{N 2} = VDD - R 1 \times It \qquad [ Equation 1 ]$$

Therefore, in the first state, the target voltage Vt corresponding to the difference between the input voltage VDD and the voltage V_{N2} stored in the second node N2 may be stored in the first capacitor C1.

The target voltage Vt according to an embodiment may be expressed as Equation 2.

$${V}_{t} = R 1 \times It \qquad [ Equation 2 ]$$

In addition, referring to FIG. 5B, the third switch SW3 and the fourth switch SW4 may be turned on while the first switch SW1 and the second switch SW2 are turned off.

For example, the first switch SW1 and the second switch SW2 may be turned off in response to a clock signal having a low level. In addition, the third switch SW3 and the fourth switch SW4 may be turned on in response to the clock signal having a low level.

In this case, it is assumed that the state in which the first switch SW1 and the second switch SW2 are turned off and the third switch SW3 and the fourth switch SW4 are turned on is a second state of the current limit circuit 140A.

While the current limit circuit 140A according to an embodiment is in the second state, a voltage equal to about half of the voltage stored in the first capacitor C1 may be stored in the second capacitor C2.

For example, when the target voltage Vt is stored in the first capacitor C1 while the current limit circuit 140A is in the first state, a voltage ½ Vt equal to half of the target voltage Vt may be stored in the second capacitor C2 while the current limit circuit 140A is switched to the second state.

In the current limit circuit 140A according to an embodiment, the first state and the second state may be alternately repeated according to a clock signal.

When the first state and the second state are alternately repeated in the current limit circuit 140A, the target voltage Vt may be stored in the second capacitor C2.

For example, when the first state and the second state are alternately repeated in the current limit circuit 140A according to the clock signal, charges corresponding to the target voltage Vt may be stored in the second capacitor C2.

Referring to FIG. 6, the ADC 143 according to an embodiment may convert the target voltage Vt into the target code TC in response to the target voltage Vt being stored in the second capacitor C2.

For example, the ADC 143 may convert the target voltage Vt, which is an analog signal, into the target code TC, which is a digital code, in response to the target voltage Vt being stored in the second capacitor C2.

In this case, for example, the target code TC may be understood as a digital code corresponding to the target voltage Vt.

Furthermore, the controller 130 may output the control code CC within the range of the limit code LC or less based on the target code TC.

According to an embodiment, the controller 130 may determine the limit code LC based on the target code TC.

The controller 130 may identify the amount of the target current It based on the target code TC.

In addition, the controller 130 may determine the maximum number of power transistors that may be turned on among the plurality of power transistors 110, based on the amount of the target current It and the amount of the preset maximum current.

For example, when the target current It is about 2 mA and the maximum current is about 1 A, the controller 130 may determine that up to 500 power transistors among the plurality of power transistors 110 may be turned on.

As another example, when the target current It is about 5 mA and the maximum current is about 1 A, the controller 130 may determine that up to 200 power transistors among the plurality of power transistors 110 may be turned on.

Furthermore, the controller 130 may determine the limit code LC corresponding to the maximum number. For example, the controller 130 may determine the code “110” corresponding to the maximum number as the limit code LC.

According to an embodiment, the controller 130 may output the control code CC within the range of the limit code LC or less.

For example, the controller 130 may output the control code CC within the range of the limit code LC or less based on the control signal CS transmitted from the comparator 120.

That is, the controller 130 may output the control code CC within the range of the limit code LC or less such that the maximum number of power transistors or less among the plurality of power transistors 110 are turned on, based on the control signal CS.

For example, when the output voltage Vout is lower than the reference voltage Vref, the controller 130 may output the control code CC to additionally turn on one power transistor within the range of the limit code LC or less in response to an increase signal UP.

That is, when the output voltage Vout is lower than the reference voltage Vref, the controller 130 may increase the control code CC by a unit code within the range of the limit code LC or less in response to the increase signal UP.

In this case, for example, the unit code may be understood as a digital code corresponding to an operation of turning on one of the plurality of power transistors 110.

As another example, when the output voltage Vout is greater than the reference voltage Vref, the controller 130 may output the control code CC to turn off one power transistor in response to a decrease signal DN.

That is, when the output voltage Vout is greater than the reference voltage Vref, the controller 130 may decrease the control code CC by the unit code in response to the decrease signal DN.

Referring to the above-described configurations, the current limit circuit 140A according to an embodiment may identify the size of the target current It flowing from the input node IN to the output node ON through the sample transistor STR.

In this case, the target current It may be understood to have an amount that is an integer multiple of the first current Ic flowing through each of the plurality of power transistors 110.

In addition, the controller 130 may determine the limit code LC corresponding to the maximum number of power transistors that may be turned on among the plurality of power transistors 110, based on the target current It.

Furthermore, the controller 130 may control at least some of the plurality of power transistors 110 by outputting the control code CC within the range of the limit code LC.

That is, the controller 130 may set the limit code LC to control the LDO regulator 100A to output a current within the range of the maximum current or less by using the sample transistor STR.

Thus, the LDO regulator 100 according to an embodiment of the present disclosure may stably limit the output current Iout regardless of the operating environment.

According to an embodiment, the controller 130 may determine the limit code LC, which represents the maximum allowable number of power transistors that can be activated among the plurality of power transistors 110, based on the detected target current It from the sample transistor STR. The target current It may serve as a reference point, allowing the controller to account for real-time current demands while operating safely.

Furthermore, the controller 130 may regulate the activation of the power transistors 110 by generating and outputting a control code CC. This control code CC may specify the exact number of transistors 110 to turn on, so that the number does not exceed the limit set by the limit code LC. By dynamically adjusting the control code CC within the range defined by the limit code LC, the controller 130 may precisely manage the output current Iout to meet the system's requirements without surpassing the safe current limit.

For example, the limit code LC may enable the controller 130 to manage the LDO regulator 100A in a way such that the output current Iout remains below or equal to the maximum allowable current. This may be implemented by way of the sample transistor STR, which provides a reliable and scalable way to monitor and limit the current across various operating conditions.

Thus, the LDO regulator 100 according to embodiments may provide stable and reliable current limiting, regardless of changes in the operating environment, such as variations in process, voltage, or temperature.

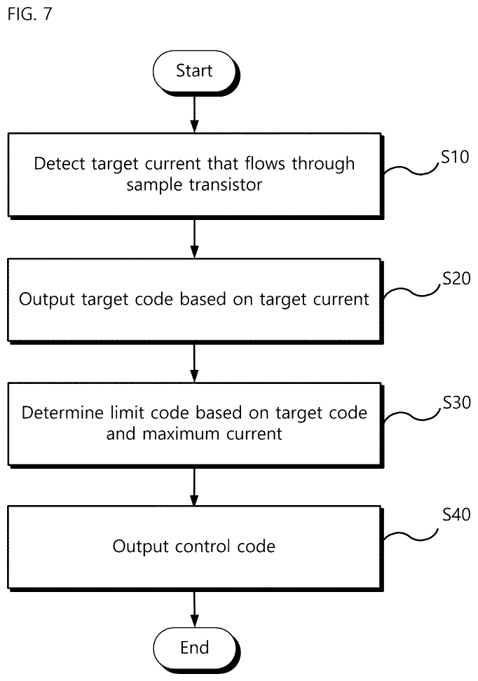

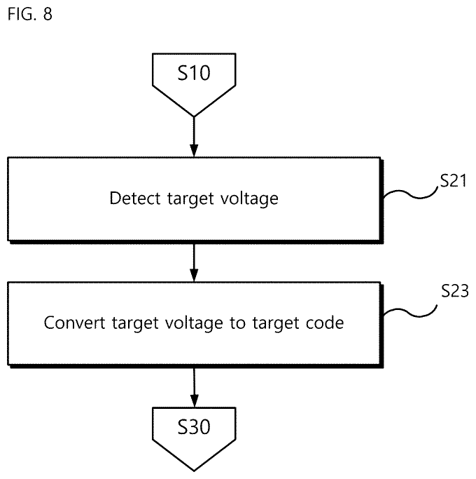

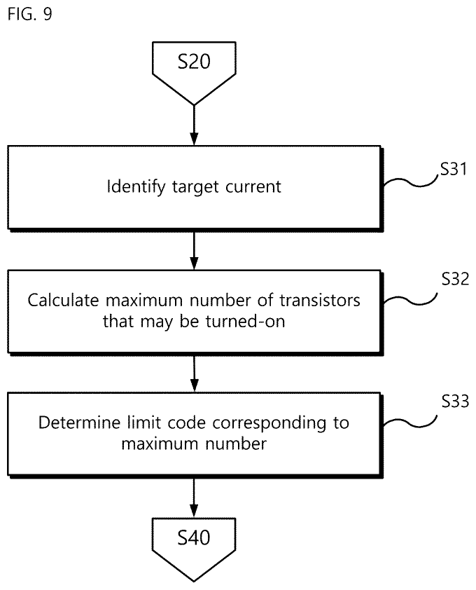

FIG. 7 is a flowchart illustrating a method of controlling an LDO regulator according to an embodiment. FIG. 8 is a flowchart illustrating a method of generating a target code from a target current according to an embodiment. FIG. 9 is a flowchart illustrating a method of determining a limit code according to an embodiment.

Referring to FIG. 7, the LDO regulator 100 according to an embodiment may output the control code CC within the range of the limit code LC or less based on the target current It flowing through the sample transistor STR.

In operation S10, the LDO regulator 100 (or the current limit circuit 140) according to an embodiment may detect the target current It flowing through the sample transistor STR.

For example, the LDO regulator 100 may detect the target current It flowing from the input node IN through the sample transistor STR.

For example, the LDO regulator 100 may detect the amount of the target current It flowing from the input node IN through the sample transistor STR through the sensing circuit 141 connected to the sample transistor STR.

According to an embodiment, the source electrode of the sample transistor STR may be connected to the input node IN to which the input voltage VDD is applied. In addition, the output voltage Vout may be applied to the drain electrode of the sample transistor STR.

In addition, each of the plurality of power transistors 110 may be connected between the input node IN to which the input voltage VDD is applied and the output node ON to which the output voltage Vout is applied.

That is, the sample transistor STR may operate under the same operating environment as each of the plurality of power transistors 110 connected in parallel between the input node IN and the output node ON.

Therefore, it may be understood that the target current It flowing through the sample transistor STR has an amount that is an integer multiple of the first current Ic flowing through each of the plurality of power transistors 110.

For example, when each of the plurality of power transistors 110 has a size equal to a first integer multiple of the sample transistor STR, the first current Ic may have an amount equal to a first integer multiple of the target current It.

Therefore, the LDO regulator 100 may determine the amount of the first current Ic flowing through each of the plurality of power transistors 110 by detecting the target current It flowing through the sample transistor STR.

In operation S20, the LDO regulator 100 (or the current limit circuit 140) according to an embodiment may output the target code TC.

For example, the LDO regulator 100 may output the target code TC corresponding to the target current It based on the target current It.

Referring to FIG. 8, the LDO regulator 100 (or the current limit circuit 140) according to an embodiment may convert the target current It into the target voltage Vt and output the target code TC.

In operation S21, the LDO regulator 100 according to an embodiment may detect the target voltage Vt. For example, the LDO regulator 100 may detect the target voltage Vt corresponding to the target current It based on the target current It.

According to an embodiment, the LDO regulator 100 may convert the target current It into the target voltage Vt through the converting circuit 142 including two different capacitors C1 and C2.

For example, the converting circuit 142 may include the first capacitor C1 in which the target voltage Vt is stored by the input voltage VDD while the current limit circuit 140 is in the first state.

In addition, the converting circuit 142 may include the second capacitor C2 in which a voltage about equal to half of the voltage stored in the first capacitor C1 is stored while the current limit circuit 140 is in the second state.

According to an embodiment, when the first state and the second state are alternately repeated in the current limit circuit 140, the target voltage Vt may be stored in the second capacitor C2.

Therefore, the LDO regulator 100 may detect the target voltage Vt in the second capacitor C2 included in the converting circuit 142.

In operation S23, the LDO regulator 100 according to an embodiment may convert the target voltage Vt into the target code TC.

For example, the LDO regulator 100 may convert the target voltage Vt, which is an analog signal, into the target code TC, which is a digital code, by using the ADC 143.

For example, the ADC 143 may convert the target voltage Vt into the target code TC in response to the target voltage Vt being stored in the second capacitor C2.

In operation S30, the LDO regulator 100 (or the controller 130) according to an embodiment may determine the limit code LC based on the target code TC.

For example, the LDO regulator 100 may determine the limit code LC based on the target code TC and the preset maximum current.

Referring to FIG. 9, the LDO regulator 100 may determine the limit code LC corresponding to the maximum number of power transistors that may be turned on based on the target code TC and the preset maximum current.

In operation S31, the LDO regulator 100 according to an embodiment may identify the target current It based on the target code TC.

For example, the LDO regulator 100 may determine the amount of the target current It based on the target code TC corresponding to the target voltage Vt.

In operation S32, the LDO regulator 100 according to an embodiment may calculate the maximum number of power transistors that may be turned on among the plurality of power transistors 110.

For example, the LDO regulator 100 may calculate the maximum number of power transistors that may be turned on among the plurality of power transistors 110 based on the amount of the target current It and the amount of the maximum current.

For example, when the target current It is about 2 mA and the maximum current is about 1 A, the controller 130 may determine that up to 500 power transistors among the plurality of power transistors 110 may be turned on.

As another example, when the target current It is about 5 mA and the maximum current is about 1 A, the controller 130 may determine that up to 200 power transistors among the plurality of power transistors 110 may be turned on.

In operation S33, the LDO regulator 100 may determine (or identify) the limit code LC corresponding to the maximum number.

For example, the LDO regulator 100 may determine the limit code LC corresponding to the maximum number of power transistors that may be turned on.

For example, the controller 130 may determine the code “110” corresponding to the maximum number as the limit code LC.

In operation S40, the LDO regulator 100 (or the controller 130) according to an embodiment may output the control code CC.

For example, the LDO regulator 100 may output the control code CC within the range of the limit code LC or less.

The LDO regulator 100 may output the control code CC within the range of the limit code LC or less based on the control signal CS transmitted from the comparator 120.

That is, the LDO regulator 100 may output the control code CC within the range of the limit code LC or less such that the maximum number or less of power transistors among the plurality of power transistors 110 are turned on, based on the control signal CS.

Referring to the above-described configurations, the LDO regulator 100 according to an embodiment may identify the amount of the target current It flowing from the input node IN to the output node ON through the sample transistor STR.

In this case, the target current It may be understood to have an amount that is an integer multiple of the first current Ic flowing through each of the plurality of power transistors 110.

In addition, the LDO regulator 100 may determine the limit code LC corresponding to the maximum number of power transistors that may be turned on among the plurality of power transistors 110, based on the target current It.

Furthermore, the LDO regulator 100 may control at least some of the plurality of power transistors 110 by outputting the control code CC within the range of the limit code LC.

That is, the LDO regulator 100 may set the limit code LC to control the output current Iout output through the output node ON to the maximum current or less by using the sample transistor STR.

Thus, the LDO regulator 100 according to an embodiment of the present disclosure may stably limit the output current Iout regardless of the operating environment.

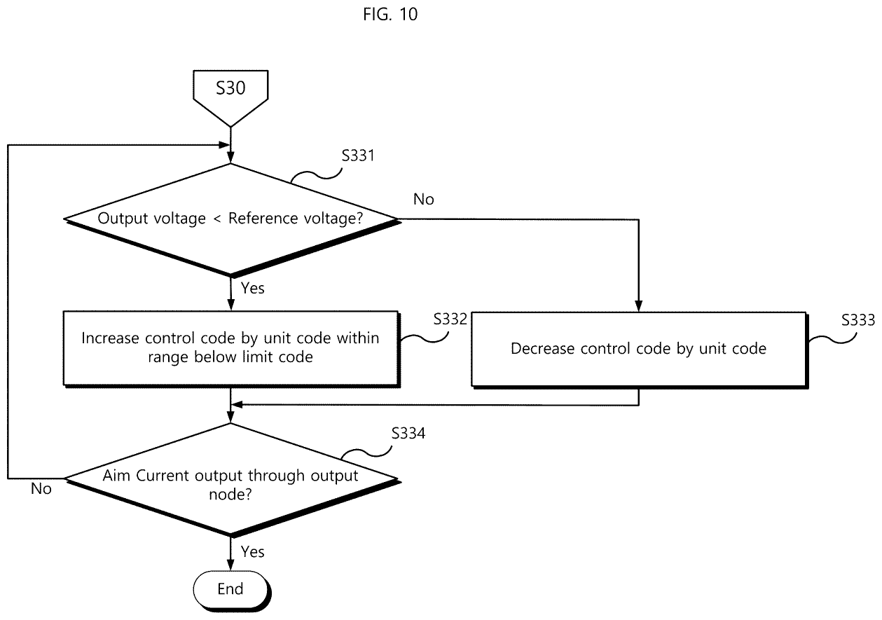

FIG. 10 is a flowchart illustrating a method of controlling a control code by a controller according to an embodiment.

Referring to FIGS. 9 and 10 together, the LDO regulator 100 according to an embodiment may control the control code CC within the range of the limit code LC based on the control signal CS.

In operation S331, the LDO regulator 100 according to an embodiment may determine whether the output voltage Vout is less than the reference voltage Vref.

For example, the LDO regulator 100 may compare the output voltage Vout with the reference voltage Vref by using the comparator 120.

Furthermore, the comparator 120 may output the control signal CS based on whether the output voltage Vout is less than the reference voltage Vref.

For example, the comparator 120 may output the increase signal UP when the output voltage Vout is less than the reference voltage Vref. In this case, the increase signal UP may be referenced as a low level signal.

As another example, the comparator 120 may output the decrease signal DN when the output voltage Vout is greater than the reference voltage Vref. In this case, the decrease signal DN may be referenced as a high level signal.

In operation S332, the LDO regulator 100 (or the controller 130) according to an embodiment may increase the control code CC by the unit code within the range of the limit code LC or less.

For example, the LDO regulator 100 may increase the control code CC by the unit code within the range of the limit code LC or less in response to the increase signal UP output from the comparator 120.

In this case, for example, the unit code may be understood as a digital code corresponding to an operation of turning on one of the plurality of power transistors 110.

Therefore, it may be understood that the operation of increasing the control code CC by the unit code by the LDO regulator 100 corresponds to a control operation of additionally turning on one of the plurality of power transistors 110.

For example, in response to the increase signal UP, the LDO regulator 100 may output the control code CC increased by the unit code to additionally turn on one power transistor within the range of the limit code LC or less.

In operation S333, the LDO regulator 100 (or the controller 130) according to an embodiment may decrease the control code CC by the unit code.

For example, the LDO regulator 100 may decrease the control code CC by the unit code in response to the decrease signal DN output from the comparator 120.

In this case, it may be understood that the operation of decreasing the control code CC by the unit code by the LDO regulator 100 corresponds to a control operation of turning off one of the plurality of power transistors 110.

For example, the LDO regulator 100 may output the control code CC reduced by the unit code to turn off one power transistor within the range of the limit code LC or less in response to the decrease signal DN.

Referring to the above-described configurations, the LDO regulator 100 according to an embodiment may control the number of power transistors 110 turned on among the plurality of power transistors through the control code CC.

Thus, the LDO regulator 100 may control the size of the output current Iout output through the output node ON.

Furthermore, in operation S334, the LDO regulator 100 according to an embodiment may determine whether the aim current is output through the output node ON.

For example, the LDO regulator 100 may determine whether the amount of the output current Iout output through the output node ON is equal to the amount of the preset aim current.

For example, the LDO regulator 100 may determine whether the output voltage Vout and the reference voltage Vref are the same through the comparator 120.

In this case, when the output voltage Vout and the reference voltage Vref are the same, the LDO regulator 100 may determine that the output current Iout has the same amount as the aim current.

Through the above-described configurations, the LDO regulator 100 according to an embodiment may control at least some of the plurality of power transistors 110 such that the aim current is output through the output node ON within the range of the limit code LC.

In this case, the LDO regulator 100 may control at least some of the plurality of power transistors 110 by generating the digital type control code CC within the range of the limit code LC.

According to an embodiment, the LDO regulator 100 that operates based on a digital code (e.g., the control code CC) may have a relatively smaller area compared to an analog LDO regulator that operates based on an analog signal.

For example, the plurality of power transistors 110 of the LDO regulator 100 that operates based on a digital code may operate in a fully turned-on state.

Meanwhile, the power transistor included in an analog LDO regulator that operates based on an analog signal may operate in a saturation state.

Therefore, the LDO regulator 100 that operates based on a digital code according to an embodiment of the present disclosure may have a reduced area.

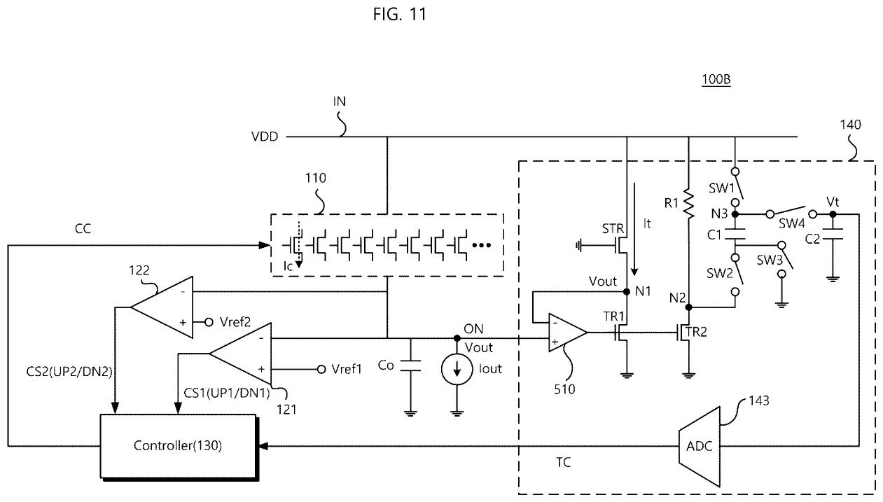

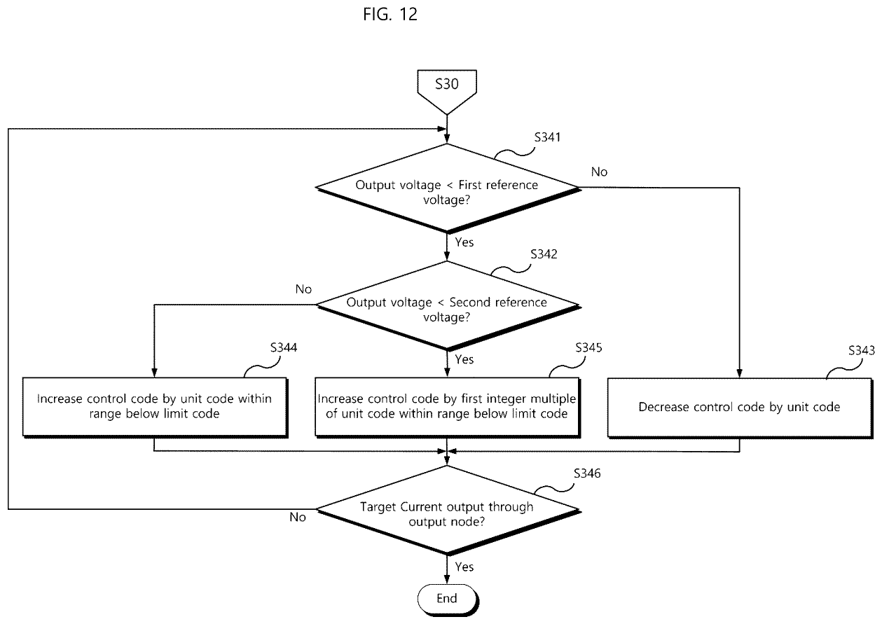

FIG. 11 is a circuit diagram illustrating an LDO regulator according to an embodiment. FIG. 12 is a flowchart illustrating a method of controlling a control code by a controller according to an embodiment.

Referring to FIG. 11, an LDO regulator 100B according to an embodiment may include the plurality of power transistors 110, a first comparator 121, a second comparator 122, the controller 130, the sample transistor STR, and the current limit circuit 140.

In this case, the LDO regulator 100B illustrated in FIG. 11 may be understood as an example of the LDO regulator 100 illustrated in FIG. 1.

Therefore, for convenience of description, the same reference numerals will be used for components that are identical or substantially identical to the components described above, and duplicate descriptions of the same components will be omitted.

For example, the LDO regulator 100B may include the first comparator 121 that compares the output voltage Vout with a first reference voltage Vref1.

In addition, the LDO regulator 100B may include the second comparator 122 that compares the output voltage Vout with a second reference voltage Vref2 that is lower than the first reference voltage Vref1.

Referring to FIG. 11 and FIG. 12 together, in operation S341, the LDO regulator 100B according to an embodiment may determine whether the output voltage Vout is lower than the first reference voltage Vref1.

For example, the LDO regulator 100B may compare the output voltage Vout with the first reference voltage Vref1 by using the first comparator 121.

Furthermore, the first comparator 121 may compare the output voltage Vout with the first reference voltage Vref1 and output a first control signal CS1.

For example, the first comparator 121 may output a first increase signal UP1 when the output voltage Vout is lower than the first reference voltage Vref1. As another example, the first comparator 121 may output a first decrease signal DN1 when the output voltage Vout is higher than the first reference voltage Vref1.

In operation S342, the LDO regulator 100B according to an embodiment may determine whether the output voltage Vout is lower than the second reference voltage Vref2.

For example, the second comparator 122 may compare the output voltage Vout with the second reference voltage Vref2 and output a second control signal CS2.

For example, the second comparator 122 may output a second increase signal UP2 when the output voltage Vout is lower than the second reference voltage Vref2. As another example, the second comparator 122 may output a second decrease signal DN2 when the output voltage Vout is higher than the second reference voltage Vref2.

In operation S343, the LDO regulator 100B according to an embodiment may decrease the control code CC by the unit code based on the first control signal CS1.

For example, when the output voltage Vout is higher than the first reference voltage Vref1, the LDO regulator 100B may reduce the control code CC by the unit code within the range of the limit code LC.

In this case, for example, it may be understood that the operation of the LDO regulator 100B according to operation S343 is substantially the same as the operation according to operation S333 illustrated in FIG. 10.

For example, the LDO regulator 100B may reduce the control code CC by the unit code within the range of the limit code LC in response to the first decrease signal DN1.

That is, the LDO regulator 100B may turn off one transistor turned on among the plurality of power transistors 110 when the output voltage Vout is higher than the first reference voltage Vref1.

In operation S344, the LDO regulator 100B according to an embodiment may increase the control code CC by the unit code within the range of the limit code LC based on the first control signal CS1 and the second control signal CS2.

For example, when the output voltage Vout is higher than the second reference voltage Vref2 and lower than the first reference voltage Vref1, the LDO regulator 100B may increase the control code CC by the unit code within the range of the limit code LC.

In this case, for example, it may be understood that the operation of the LDO regulator 100B according to operation S344 is substantially the same as the operation according to operation S332 illustrated in FIG. 10.

For example, the LDO regulator 100B may increase the control code CC by the unit code within the range of the limit code LC in response to the first increase signal UP1 and the second decrease signal DN2.

That is, when the output voltage Vout is higher than the second reference voltage Vref2 and lower than the first reference voltage Vref1, the LDO regulator 100B may turn on one turned-off transistor among the plurality of power transistors 110.

In operation S345, the LDO regulator 100B according to an embodiment may increase the control code CC by a second integer multiple of the unit code within the range of the limit code LC based on the second control signal CS2.

For example, when the output voltage Vout is lower than the second reference voltage Vref2, the LDO regulator 100B may increase the control code CC by the second integer multiple of the unit code within the range of the limit code LC.

For example, the LDO regulator 100B may increase the control code CC by twice the unit code within the range of the limit code LC in response to the second increase signal UP2.

That is, when the output voltage Vout is lower than the second reference voltage Vref2, the LDO regulator 100B may turn on a second integer number of power transistors among the plurality of power transistors 110.

For example, the LDO regulator 100B may turn on two of the plurality of power transistors 110 by increasing the control code CC by twice the unit code.

Furthermore, in operation S346, the LDO regulator 100B according to an embodiment may determine whether the aim current is output through the output node ON.

For example, the LDO regulator 100B may determine whether the amount of the output current Iout output through the output node ON is about equal to the amount of the preset aim current.

For example, the LDO regulator 100B may determine whether the output voltage Vout and the first reference voltage Vref1 are the same through the first comparator 121.

In addition, for example, when the output voltage Vout and the first reference voltage Vref1 are the same, the LDO regulator 100B may determine that the output current Iout has the same amount as the aim current.

Referring to the above-described configurations, the LDO regulator 100B according to an embodiment may control the control code CC by an integer multiple of the unit code when the output voltage Vout is lower than the preset reference voltage (e.g., the second reference voltage Vref2).

Thus, the LDO regulator 100B according to an embodiment of the present disclosure may reduce the time required to control the output current Iout to be output as much as the aim current through the output node ON.

As described above, the current limit circuit 140 according to an embodiment may identify the amount of a current (e.g., the target current It) flowing from the input node IN to the output node ON through the sample transistor STR.

Furthermore, the controller 130 may determine the limit code LC corresponding to the maximum number of power transistors that may be turned on among the plurality of power transistors 110, based on the target current It.

In addition, the controller 130 may control at least some of the plurality of power transistors 110 by outputting the control code CC within the range of the limit code LC.

That is, the controller 130 may set the limit code LC for controlling the LDO regulator 100 to output a current within the range of the maximum current or less by using the sample transistor STR.

Thus, the LDO regulator 100 according to an embodiment of the present disclosure may stably limit the output current Iout regardless of the operating environment.

In addition, the LDO regulator 100 according to an embodiment may control the control code CC by an integer multiple of the unit code when the output voltage Vout is lower than the preset reference voltage (e.g., the second reference voltage Vref2).

Thus, the LDO regulator 100 according to an embodiment of the present disclosure may reduce the time required to control the output current Iout to be output as much as the aim current through the output node ON. That is, the LDO regular 100 may reduce the time needed to adjust the output current Iout to match the aim current at the output node ON.

As is traditional in the field of the present disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. A low-dropout (LDO) regulator, comprising:
a plurality of power transistors connected in parallel between an input node to which an input voltage is applied and an output node;
a comparator configured to compare an output voltage of the output node with a reference voltage, and output a control signal based on a comparison result obtained by comparing the output voltage with the reference voltage;
a controller configured to output a control code that controls at least some of the plurality of power transistors based on the control signal such that an output current equal to an aim current flows through the output node; and
a current limit circuit configured to detect a target current output from a sample transistor connected to the input node and output a target code corresponding to the target current,
wherein the controller is configured to determine a limit code based on the target code and a preset maximum current, and output the control code within a range defined by the limit code.

2. The LDO regulator of claim 1, wherein the current limit circuit includes:
a sensing circuit configured to detect the target current;
a converting circuit configured to convert the target current into a target voltage corresponding to the target current; and
an analog-to-digital converter (ADC) configured to convert the target voltage into the target code.

3. The LDO regulator of claim 2, wherein the sensing circuit includes a first transistor connected between the sample transistor and a ground, and an error amplifier connected to the first transistor,
a first input terminal of the error amplifier is connected to the output node,
a second input terminal of the error amplifier is connected to a first node between the sample transistor and the first transistor,
an output terminal of the error amplifier is connected to a gate electrode of the first transistor, and
the output voltage is applied to the first node.

4. The LDO regulator of claim 3, wherein the converting circuit includes:
a first resistor and a second transistor connected in series between the input node and the ground;
a first capacitor connected between a second node between the first resistor and the second transistor, and the input node;
a second capacitor connected between a third node between the first capacitor and the input node, and the ground;
a first switch connected between the input node and the third node;
a second switch connected between the first capacitor and the second node;
a third switch connected between the first capacitor and the ground; and
a fourth switch connected between the third node and the second capacitor.

5. The LDO regulator of claim 4, wherein the first switch and the second switch are turned on and off repeatedly according to a specified cycle, and
the third switch and the fourth switch are turned off while the first switch and the second switch are turned on, and are turned on while the first switch and the second switch are turned off.

6. The LDO regulator of claim 5, wherein the ADC is further configured to convert the target voltage into the target code and output the target code in response to the target voltage being stored at two terminals of the second capacitor.

7. The LDO regulator of claim 1, wherein the controller is further configured to:
identify the target current based on the target code;
calculate a maximum number of transistors to be turned on among the plurality of power transistors based on the target current and the preset maximum current; and
output the control code within the range defined by the limit code corresponding to the maximum number, and turn on a number of transistors, among the plurality of transistors, less than or equal to the maximum number, in response to the outputted control code.

8. The LDO regulator of claim 7, wherein the controller is further configured to:
decrease the control code by a unit code in response to a decrease signal output from the comparator when the output voltage is greater than the reference voltage; and
increase the control code by the unit code within the range defined by the limit code in response to an increase signal output from the comparator when the output voltage is less than the reference voltage.

9. The LDO regulator of claim 3, further comprising:
an output capacitor connected between the output node and the ground,
wherein a charge stored in the output capacitor moves to the output node when the output voltage is less than the reference voltage.

10. The LDO regulator of claim 1, wherein each of the plurality of power transistors has a size equal to a first integer multiple of the sample transistor, and
a current equal to the first integer multiple of the target current flows from the input node to the output node through each of the plurality of power transistors.

11. A method of controlling a low-dropout (LDO) regulator, the method comprising:
detecting a target current flowing through a sample transistor connected between an input node to which an input voltage is applied and a first node to which an output voltage is applied;
outputting a target code corresponding to the target current based on the target current;
determining a limit code based on the target code and a preset maximum current; and
outputting a control code that controls at least some of a plurality of power transistors connected between the input node and an output node within a range defined by the limit code such that an output current equal to an aim current flows through the output node to which the output voltage is applied.

12. The method of claim 11, wherein determining the target code includes:
detecting a target voltage corresponding to the target current based on the target current; and
converting the target voltage into the target code in digital format by using an analog-to-digital converter (ADC).

13. The method of claim 11, wherein determining the limit code includes:
identifying the target current based on the target code;
calculating a maximum number of transistors to be turned on among the plurality of power transistors based on the target current and the maximum current; and
determining the limit code corresponding to the maximum number.

14. The method of claim 13, wherein outputting the control code includes:
comparing the output voltage with a first reference voltage by using a first comparator;
decreasing the control code by a unit code in response to a first decrease signal output from the first comparator when the output voltage is greater than the first reference voltage; and
increasing the control code by the unit code within the range defined by the limit code in response to a first increase signal output from the first comparator when the output voltage is less than the first reference voltage.

15. The method of claim 14, wherein outputting the control code further includes:
comparing the output voltage with a second reference voltage by using a second comparator; and
increasing the control code by an integer multiple of the unit code within the range defined by the limit code in response to a second increase signal output from the second comparator when the output voltage is less than the second reference voltage.

16. A semiconductor device including a low-dropout (LDO) regulator that operates based on a digital code, the semiconductor device comprising:
a plurality of power transistors connected between an input node and an output node;
a first comparator configured to compare an output voltage applied to the output node with a first reference voltage, and output a first control signal based on a first comparison result obtained by comparing the output voltage with the first reference voltage;
a controller configured to output a control code that turns on at least some of the plurality of power transistors based on the first control signal such that an output current equal to an aim current is output through the output node; and
a current limit circuit configured to detect a target current output from a sample transistor connected to the input node and output a target code corresponding to the target current,
wherein the controller is further configured to determine a limit code based on the target code and a preset maximum current, and output the control code within a range defined by the limit code.

17. The semiconductor device of claim 16, wherein the current limit circuit includes:
a sensing circuit configured to detect the target current;
a converting circuit configured to convert the target current into a target voltage corresponding to the target current; and
an analog-to-digital converter (ADC) configured to convert the target voltage into the target code.

18. The semiconductor device of claim 16, wherein the controller is further configured to:
identify the target current based on the target code;
calculate a maximum number of transistors to be turned on among the plurality of power transistors based on the target current and the maximum current; and
output the control code within the range defined by the limit code corresponding to the maximum number, and turn on a number of transistors, among the plurality of transistors, less than or equal to the maximum number, in response to the outputted control code.

19. The semiconductor device of claim 18, wherein the controller is further configured to:
decrease a size of the control code by a unit code in response to a first decrease signal output from the first comparator when the output voltage is greater than the first reference voltage; and
increase the size of the control code by the unit code within the range defined by the limit code in response to a first increase signal output from the first comparator when the output voltage is less than the first reference voltage.

20. The semiconductor device of claim 19, further comprising:
a second comparator configured to compare the output voltage with a second reference voltage that is lower than the first reference voltage, and output a second control signal based on a second comparison result obtained by comparing the output voltage with the second reference voltage,
wherein the controller is further configured to increase the size of the control code by an integer multiple of the unit code within the range defined by the limit code in response to a second increase signal output from the second comparator when the output voltage is lower than the second reference voltage.
